(19) United States
(12) Patent Application Publication
(10) Pub. No.: US 2016/0295367 A1
(43) Pub. Date: Oct. 6, 2016

(54) PROXIMITY-BASED SERVICES

(71) Applicant: NOKIA SOLUTIONS AND NETWORKS OY, Espoo (FI)

(72) Inventors: Ling Yu, Kauniainen (FI); Vinh Van Phan, Oulu (FI); Yixue Lei, Beijing (CN); Zexian Li, Espoo (FI); Zhi Zhang, Beijing (CN)

(21) Appl. No.: 15/032,453

(22) PCT Filed: Nov. 1, 2013
(86) PCT No.: PCT/EP2013/072872

§ 371 Date: Apr. 27, 2016

(51) Int. Cl. H04W 4/02; H04W 8/00; H04W 72/04

(52) U.S. Cl. CPC H04W 4/023; H04W 72/04; H04W 8/005

(57) ABSTRACT

The invention is related to an apparatus, comprising: at least one processor and at least one memory including computer code for one or more programs, the at least one memory and the computer code configured, with the at least one processor, to cause the apparatus at least to: receive a signal from a first user device, the signal being transmitted using at least one resource of one group of a plurality of resource groups, the one of the plurality of resource groups being associated with a first range class; and determine the first range class based on the one of the plurality of resource groups.

### FIELD

The present application relates to proximity service and in particular but not exclusively to discovery in proximity services.

### BACKGROUND

A communication system may be seen as a facility that enables communication sessions between two or more nodes such as fixed or mobile communication devices, access points such as nodes, base stations, servers, hosts, machine type servers, routers, and so on. A communication system and compatible communicating devices typically operate in accordance with a given standard or specification which sets out what the various entities associated with the system are permitted to do and how that should be achieved. For example, the standards, specifications and related protocols may define the manner how communication devices shall communicate with the access points, how various aspects of the communications shall be implemented and how the devices and functionalities thereof shall be configured.

An example of cellular communication systems is an architecture that is being standardized by the 3rd Generation Partnership Project (3GPP). A recent development in this field is often referred to as the long-term evolution (LTE) or long-term evolution advanced (LTE advanced) of the Universal Mobile Telecommunications System (UMTS) radio-access technology. In LTE base stations providing the cells are commonly referred to as enhanced NodeBs (eNB). An eNB may provide coverage for an entire cell or similar radio service area. It should be appreciated that even the embodiments are described in relation to LTE—Advanced system, it may be implemented to any communication system being suitable to proximity-based services.

A user may access the communication system by means of an appropriate communication device. A communication device of a user is often referred to as user device (UE), user device or terminal. A communication device is typically provided with an appropriate signal receiving and transmitting arrangement for enabling communications with other parties. In wireless systems a communication device typically provides a transceiver station that may communicate with another communication device such as e.g. a base station and/or another user device. A communication device such as a user device (UE) may access a carrier provided by a base station, and transmit and/or receive on the carrier.

Signals may be carried on wired or wireless carriers. Examples of wireless systems include public land mobile networks (PLMN), satellite based communication systems and different wireless local networks, for example wireless local area networks (WLAN). Wireless systems may be divided into coverage areas referred to as cells, such systems being often referred to as cellular systems. Different types of cells may provide different features. For example, cells may have different shapes, sizes, functionalities and other characteristics. A cell is typically controlled or provided by a control node, access node or like.

A communication system may support proximity-based services or location-based services such as a device-to-device (D2D) or proximity services (ProSe) communication in which a user device or user equipment or other device of similar hierarchy may communicate directly with another user device. For example, a user device may transmit directly to another user device without having to traverse a base station, or node (such as a (e)NodeB.

### SUMMARY

According to one aspect, there is provided a method comprising: receiving a signal from a first user device, the signal being transmitted using at least one resource of one group of a plurality of resource groups, the one of the plurality of resource groups being associated with a first range class; and determining the first range class based on the one of the plurality of resource groups

According to another aspect, there is provided an apparatus, said apparatus comprising at least one processor and at least one memory including computer code for one or more programs, the at least one memory and the computer code configured, with the at least one processor, to cause the apparatus at least to: receive a signal from a first user device, the signal being transmitted using at least one resource of one group of a plurality of resource groups, the one of the plurality of resource groups being associated with a first range class; and determine the first range class based on the one of the plurality of resource groups.

According to another aspect, there is provided an apparatus comprising: means for receiving a signal from a first user device, the signal being transmitted using at least one resource of one group of a plurality of resource groups, the one of the plurality of resource groups being associated with a first range class; and means for determining the first range class based on the one of the plurality of resource groups

Different ones of the plurality of resource groups may be associated with different range classes.

According to another aspect, there is provided a method comprising: selecting a resource group from a plurality of resource groups based on a range class of a user device carrying out proximity-based service discovery, wherein each of the plurality of resource groups is associated with a range class, and causing a signal to be transmitted on at least one resource of the selected group.

According to another aspect, there is provided an apparatus comprising: means for selecting a resource group from a plurality of resource groups based on a range class of a user device carrying out proximity-based service discovery, wherein each of the plurality of resource groups is associated with a range class, and means for causing a signal to be transmitted on at least one resource of the selected group.

According to another aspect, there is provided an apparatus, said apparatus comprising at least one processor and at least one memory including computer code for one or more programs, the at least one memory and the computer code configured, with the at least one processor, to cause the apparatus at least to: select a resource group from a plurality of resource groups based on a range class of a user device carrying out proximity-based service discovery, wherein each of the plurality of resource groups is associated with a range class; and cause a signal to be transmitted on at least one resource of the selected group.

According to another aspect, there is provided a method comprising: associating each of a plurality of resource groups with a respective range class of a plurality of range classes; and causing information to be transmitted indicating the association to a plurality of user devices.

According to another aspect, there is provided an apparatus comprising: means for associating each of a plurality of resource groups with a respective range class of a plurality of range classes; and means for causing information to be transmitted indicating the association to a plurality of user devices.

According to another aspect, there is provided a method comprising: receiving a signal from a first user device at a second user device, the signal having a reception power and indicating a first proximity-based service range class associated with the first user device; selecting a threshold based on a second proximity-based service range class associated with the second user device and the first proximity-based service range; and determining, if proximity-based service is supported between the first and the second user device based on the threshold and the reception power.

According to another aspect, there is provided an apparatus comprising: means for receiving a signal from a first user device at a second user device, the signal having a reception power and indicating a first proximity-based service range class associated with the first user device; means for selecting a threshold based on a second proximity-based service range class associated with the second user device and the first proximity-based service range; and means for determining, if proximity-based service is supported between the first and the second user device based on the threshold and the reception power.

According to another embodiment, there is provided an apparatus, said apparatus comprising at least one processor and at least one memory including computer code for one or more programs, the at least one memory and the computer code configured, with the at least one processor, to cause the apparatus at least to: receive a signal from a first user device at a second user device, the signal having a reception power and indicating a first proximity-based service range class associated with the first user device; select a threshold based on a second proximity-based service range class associated with the second user device and the first proximity-based service range; and determine, if proximity-based service is supported between the first and the second user device based on the threshold and the reception power.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

### LIST OF DRAWINGS

Embodiments of the present application will now be described with reference to the following figures in which:

FIG. 1 shows an example of a communications system in which some embodiments may be implemented;

FIG. 2 is a signal flow diagram depicting the signal flow according to some embodiments;

FIGS. 3A, 3B and 3C are flow diagrams depicting the method steps carried out in accordance with some embodiment;

FIG. 4 is a graph depicting beacon transmit power and threshold for different ranges;

FIG. 5 is a flow diagram depicting the method steps carried out in using thresholds;

FIG. 6 shows a schematic diagram of a mobile communication device according to some embodiments; and

FIG. 7 shows a schematic diagram of a control apparatus according to some embodiments.

### DESCRIPTION

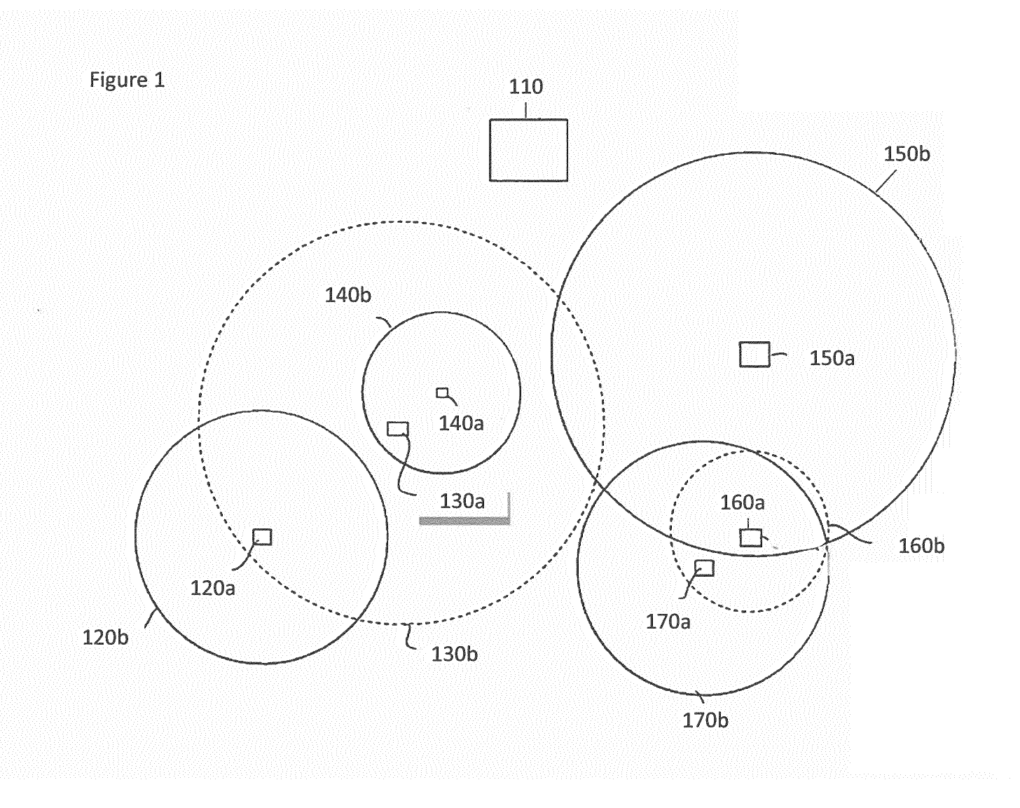

An exemplifying communication system in which devices may communicate with each other is shown in FIG. 1.

FIG. 1 comprises a network entity 110 or an access node, for example, a node B, eNode B, base station, host or server. The access node may provide a cell. FIG. 1 further shows a plurality of user device, user devices or mobile terminals 120a, 130a, 140a, 150a, 160a and 170a. The access node 110 may be configured to communicate with the user device and other access nodes and/or network entities. The access node 110 may also facilitate communication between the user device.

The communication system 100 may provide proximity-based services or location-based services. For example, the communication system 100 may have a proximity-based service communication capability. In the exemplifying system, a first user device, for example user device 120a, may communication with a second user device, for example the user device 140a, by the two user device 120a and 140a transmitting signals to and/or from each other. In such systems, the access point 110 (or other suitable network node) may configure the user device to carry out proximity-based services.

The user device (also called UE, user device, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network.

The user device (or in some embodiments a layer 3 relay node) may be configured to perform one or more of user device functionalities. The user device may also be called a subscriber unit, mobile station, remote terminal, access terminal, user terminal or user device (UE) just to mention but a few names or apparatuses.

It will be appreciated that proximity-based services or location-based services may be implemented in a plurality of manners. In some examples, user devices may communicate with each other by using a direct radio link. A user device may also act as a relay for one or more user devices, for example, two user devices may communicate with each other via another user device. Further or additional implementation of proximity-based services may include a device-to-device cluster in which one user device may act as a cluster header (for example providing some services which are typically provided by an access node in order to coordinate device-to-device communication device within the cluster.

In order a user device is able to determine whether there are one or more other user devices available for proximity-based or location-based communication, the user device may carry out a discovery process, such as ProSe/D2D discovery. A user device may carry out a discovery process itself or it may be discovered by another user device periodically or occasionally, for example on the receipt of a beacon or discovery signal from another user device or by initiating device-to-device communication. A user device carrying out a discovery may detect the presence of another user devices based on a signal it transmit. On the other hand, by receiving a signal, a user device may detect a another user device with which it may want to communicate. The signal may be a beacon transmitted by a user device to indicate its availability for proximity-based services.

In order to facilitate a discovery or discovery process (and/or selection of user devices that are appropriate to proximity-based communication), each user device or selected user devices may be provided with discovery range information. This discovery range information may relate to a range class associated with the use device. The range class may be seen as a rough indication of a distance for use in (ProSe) discovery, based, for example, on a geographical distance, conditions of a radio channel, etc. The number of range classes may vary case by case. For example, a ProSe discovery is designed to support at least three range classes corresponding to a short, medium or maximum range. Each class and/or the number of classes may be adopted according to current needs, area topology, the number of devices in the area, etc. The range classes or their hierarchy may be determined by an operator, for instance, as a part of a network configuration or as a separate action. It may also be updated according to needs. For example, a range class may indicate that a user device suitable for proximity-based services should be within a certain range from the user device carrying out the discovery.

It should be appreciated that a user device may be associated with a maximum range class available. For example, if radio conditions (for example interference or attenuation of a radio signal due to obstacles) indicate that a user device is only able to carry out device-to-device (D2D) communication over a short range, the user device may be associated with a range class corresponding to a short range.

A user device carrying out discovery may be authorised or provided with a discovery range class to use when discovering other user device(s). According to some examples, the user device may request and receive a range class. The network entity responsible for controlling ranges or only informing them may be a network node.

A user device being part of a discovery may be authorised or provided with a range class. The user device may request and receive the range class from a network node, for example. The range class may be used to prevent establishing a device-to-device communication to a user device carrying out the discovery, if it is too far away. For example, FIG. 1 shows a first user device carrying out discovery 130a with a discovery range 130b. The user device 130a may discover other user devices within this range. FIG. 1 also shows a second user device 160a with a discovery range 160b.

In the example of FIG. 1, it is also depicted a number of further user devices 120a, 140a, 150a and 170a. Also these may be associated with ranges in which they are allowed to be discovered or to discover. The ranges are 120b, 140b, 150b and 170b. It should be understood that, if a suitable device is not discovered, no proximity-based communication may take place.

It will also be appreciated that a user device may be in both roles in the discovery: it may carry out a discovery and to be discovered (or “invited” to proximity-based communications). It will be appreciated that the term “discover” may refer to discovering that a detected user device is suitable for device-to-device communication. In some embodiments, a user device to be detected may be discovered when within the discovery range. It will be appreciated that a user device may be considered detected by a user device carrying out the discovery when it receives a beacon signal.

In some embodiments of the present application, a user device may receive information indicating a discovery range of its own and/or information on a discovery range of at least one other user device.

Some embodiments of the present application may reduce the signalling overhead associated with information relating to a discovery range.

Embodiments of the present application relate to the discovery of a user device for proximity-based or location-based services.

In one embodiment, a user device may determine that a second user device is within its discovery range is based on the transmission power of a discovery signal or beacon transmitted by the second user device. Usually, the closer to the first user device the second user device is, the stronger the signal or beacon will be.

In another embodiment, the second user device may include two bits in its signal/beacon to identify the range class of the second user device. In other words, in the example case, the second user device may indicate whether it may be discovered in a short, medium or maximum range of the first user device. The second user device may indicate the intended range class.

In an embodiment, a second (discoverable) user device may transmit a discovery signal/beacon using a resource group associated with the range class of the second (discoverable) user device. A user device, receiving the discovery signal/beacon, may determine a range class of the second user device based on the resource group of the discovery signal beacon. The user device may also use a transmission power of the received signal along with the range class information to determine whether the first user device falls within the range class of the second user device.

Information associating resource groups with respective range classes may be provided to a user device by a network node. In some embodiments, the network node may be an access node, for example a base station, (e)node B, host or server. In other embodiments, the information may be provided by a network entity of a higher hierarchy level than the user device or a network entity with access to the communication network. In some embodiments, this information is discovery range class configuration information.

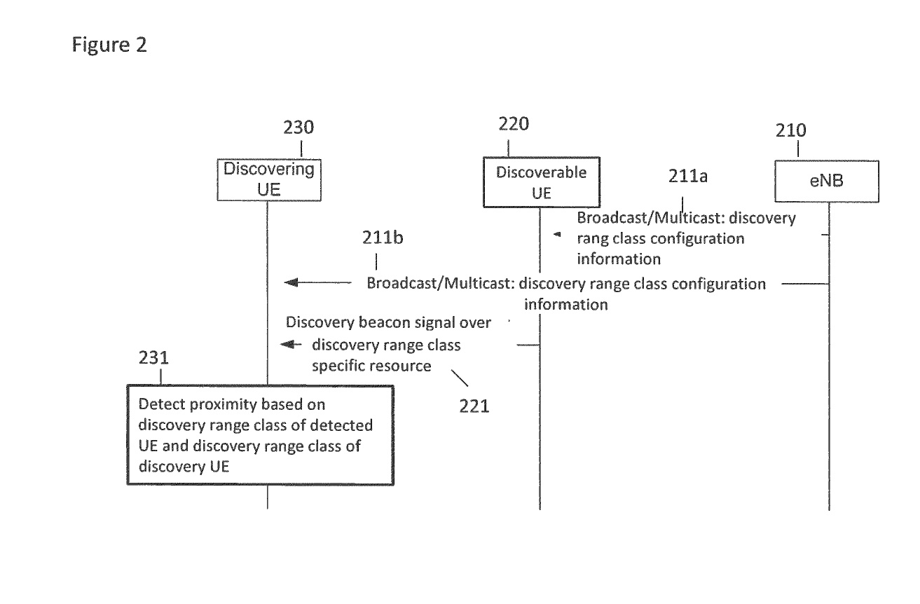

FIG. 2 is a signalling diagram showing an example of the signalling for providing discovery class configuration information to user device.

FIG. 2 comprises a first (discovering) user device 230, a second (discoverable) user device 220 and an access node 210. FIG. 2 shows the signalling between the access node 210, the second (discoverable) user device 220 and the first (discovering) user device 230 for carrying out discovery in accordance with embodiments. It will be appreciated that this is by way of example only and the signalling may include more discovering and/or discoverable user device.

It will be appreciated that a user device may carry out the method steps associated with discovering and/or being discovered. Therefore a discovering user device does not limit it to be only such a user device, but merely a user device carrying out the discovering in accordance of this example. Similarly, a discoverable user device is not limited to being a discoverable user device only.

Each user device (either discovering user device or discoverable user device), is aware of the range class it has been authorised to use. This may be based on higher layer configuration and indication. A user of the user device may configure the range class of the user device via application software (the user may define in application software that he would like to discover/be discovered within a short/medium/large range class), and/or some application software may have a specific device-to-device discovery range class configuration associated with it.

For example, referring back to FIG. 1, the first discovering user device 130a may have a maximum discovering range 130b corresponding to a maximum discovery range class. The second discovering user device 160a may have a short discovering range 160b corresponding to a small discovery range class. It will be appreciated that maximum and short are by way of example. For example, a first range class may comprise a first range whereas a second range class may comprise a second range (this second range may for example encompass the first). It will be appreciated that there may be one or more range classes and that the number of the range classes may vary even in a same cell from time to time or it may be application or service-specific.

It may also be seen from FIG. 1 that the user device 120a and 170a may have small discoverable range classes, while the user device 150a may have a maximum discoverable range class for example.

It may be seen that a user device is only aware of its own range class. FIG. 2 shows an example of the signalling associated with communicating information allowing a user device to determine the range class of a further user device to be used in the discovery process. The embodiment of FIG. 2 may provide this information in the form of discovery range class configuration information. At steps 211a and 211b of FIG. 2, the access node 210 may transmit discovery range class configuration information to the user devices 230 and 220. While two user devices are depicted in FIG. 2, the access node 210 typically transmits discovery range class configuration information to them both. However, it will be appreciated that if more user devices are present, the access node will typically transmit the discovery range configuration information to them too. In one implementation, the access node may multicast the discovery range class configuration information, however in other embodiments, this information may be transmitted to the user device in a different manner, for example the information may be broadcast.

The discovery range class configuration information may include information a user device may use to determine a range class of a further user device. This determination may be based on a discovery signal/beacon transmitted by the further user device. For example, the discovery range class configuration information may comprise one or more of resource groups (or a set of resources groups) with each group associated with a range class. Herein the resource group may be defined by the discovery sequence and/or the time and frequency resources used for D2D discovery signal/beacon transmission. The resource groups may correspond to resources to be used in the transmission of a discovery signal/beacon. This may enable the range class of a user device to be determined from a resource group used by that user device to transmit a discovery signal/beacon. A resource group may comprise a pool of resources from which the resource(s) used to transmit the discovery signal/beacon may be selected.

In some embodiments, the discovery range class configuration information may further or alternatively comprise information to be used to determine whether a user device is discoverable. For example the discovery range class configuration information may include one or more thresholds (or a set of thresholds) for each range class of discovery user device. A threshold for each range class of a discoverable user device may be provided. The thresholds may relate to a received transmission power of a discovery signal/beacon and may be used to determine whether a discoverable user device and discovery user device are within each other's range classes.

In some embodiments, the discovery range class configuration information may comprise an indication of a transmission power for a discovery signal/beacon associated with each range class.

In some embodiments, these discovery range class configuration parameters may be explicitly indicated by an access node (in FIG. 2, 210) or in other embodiments, be implicitly indicated and derived by a user device. The implicit indication may for example relate to cell specific configuration parameters (for example cell size of a serving cell or reference signal power of a serving cell). In some examples, some parameters may be explicitly indicated with other parameters being implied.

The user device may determine discovery range class configuration parameters from discovery range class configuration information for example as described above. These discovery range class parameters may include discovery signal/beacon transmission power associated with each range class, resource groups associated with each range class and/or threshold information. In one example the parameters may be:
A discovery signal or beacon transmission power for each range class. The transmission power may be indicated explicitly for each range class, or implicitly, for example only transmission powers for maximum and minimum range classes and the number of range classes may be indicated. The user device may derive the transmission power for a specific range class accordingly. In another example the transmission power for one range class (e.g. maximum or minimum range class) may be indicated and rules to derive the transmission power for the other classes may be either hard-coded or indicated. For an implicit indication option, the transmission power of different range class may be derived from for example cell size or reference signal power of a serving cell based on either pre-defined rules or indicated rules by the network. For example, the transmission power of maximum range class may be set corresponding to the cell size or according to reference signal power with given offset.
Discovery resource (i.e. a discovery beacon signal sequence and frequency/time resource allocated for a discovered beacon signal transmission) group for each range class: In some embodiments, the resource group division may be equal so that the discovery resource group for each range class may be determined based on the number of supported range classes. In other embodiments, the group division may be explicitly indicated by the serving network to allow more dynamic change of discovery resource groups for each range class.
Range class dependent discovery detection threshold: this threshold may used by a discovering user device to determine whether detected beacon (from a detected user device) may be regarded as proximity discovered or not based on which discovered range class the user device transmitting the beacon belongs to. The threshold may be given explicitly for each range class, or the threshold for certain range class is given explicitly and the threshold for other range class may be derived accordingly based on the indicated discovery beacon transmission power for each range class.

At step 221 of FIG. 2, a discovering user device 230 may receive a discovery signal/beacon from a further user device 220. The discovering user device may use the discovery beacon to determine whether the user device 220 may be discovered. The discovery signal/beacon may be transmitted using at least one resource of a group of resources associated with a range class of the user device transmitting the discovery signal/beacon.

At step 231, the discovering user device may determine whether the discoverable user device may be discovered. This determination may be based on a discovered range class of detected user device (in other words the range in which the discovery user device is allowed be in with respect to the discoverable user device for the discoverable user device to be discovered) and a discovery range class of the discovery user device (the range in respect of the discovery user device in which a discoverable user device is allowed to be discovered by the discovery user device).

The discoverable user device may identify its range class to the discovery user device by transmitting a discovery signal/beacon using the resources associated with that range class. A resource group may be associated with the range class of the discoverable user device and the discovery signal/beacon may be transmitted using at least one resource of the group of resources. The discovery user device may be aware of its own discovery range. The discovery user device may determine whether the discoverable user device is within its discovery range and whether it is within the user device's discovery range through the use of thresholds.

Different ones of a plurality of resource groups may be associated with different range classes. The range class may be a proximity services parameter to be used in proximity-based service discovery. The first range class may be a range class in which the user device is discoverable for a proximity-based service. The signal may be a beacon indicating that the first user device is available for proximity-based service. The method may comprise receiving information indicating an association of each of the plurality of resource groups with a respective range class.

The information may be received from a network node, host or server providing communication services. The information may further indicate at least one of: a transmission power associated with at least one range class; and at least one of threshold associated with the at least one range class. The information may be received via one of the following: a multicast transmission of the network node, host or server; and broadcast transmission of the network node, host or server. The method may be carried out in an apparatus. The apparatus may be in a user device.

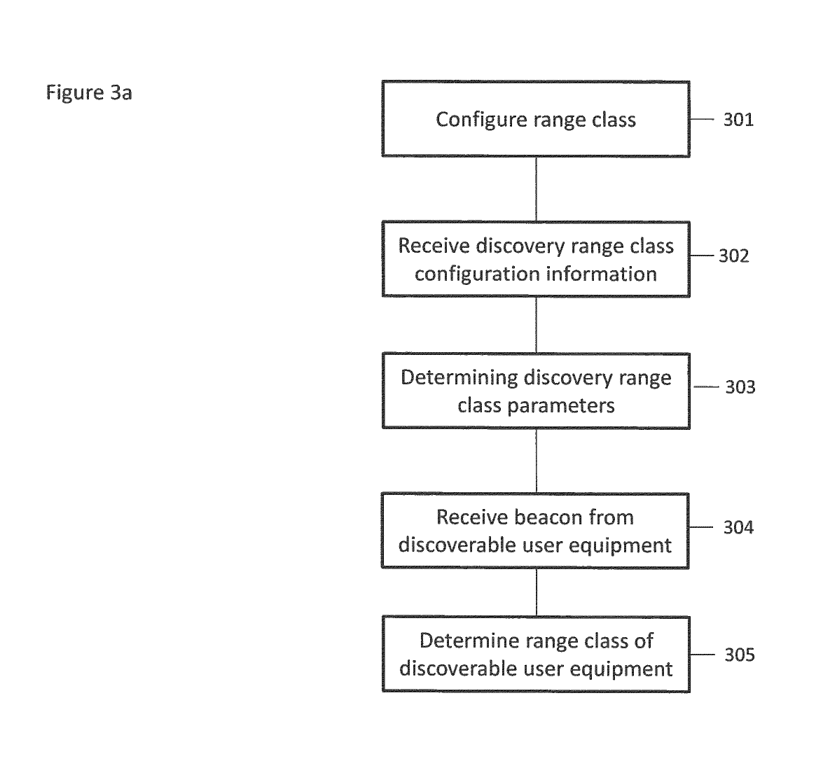

FIG. 3a is an exemplifying flow diagram depicting the method steps of carried out by a discovering user device, for example the user device 230 or the user devices 130a and 160a, according to one embodiment.

At step 301, a range class of the user device may be configured. The range class may be configured for example by a user of the user device using an application software and based on user preference, or may be configured by an application running on the user device requiring a certain range class in order to carry out device to device communication or proximity services.

At step 302, the user device receives discovery range class configuration information from a network node, for example the network node 210 or 110. In this embodiment, the discovery range class information may associate a resource group with a range class. The resource group may be a group of resources, one or more of which may be used to transmit a discovery signal/beacon.

It will be appreciated that while steps 301 and 302 are depicted as being sequential, they may be executed concurrently or in a different order.

At step 303, the discovery user device may determine discovery range class parameters from the discovery range class configuration information. The configuration information may be explicitly and/or implicitly indicate one or more of the parameters and the parameters are determined accordingly.

At step 304, the discovery user device 230 may receive a discovery signal/beacon 221 from a discoverable user device.

At step 305, the discovery user device may determine the range class of the discoverable user device based on the discovery signal/beacon and the discovery range class configuration information/parameters, For example the discovering user equipment may determine in which group of resources the resources used to transmit the discovery signal/beacon falls in. The range class may then be determined based on which range class is associated with the group of resources.

In some embodiments, the discovery user device may further determine whether or not to discover the discoverable user device. For example, the discovery user device may further determine whether the discoverable user device and discovery user device are within each other's ranges.

FIG. 3b is an exemplifying flow diagram depicting the method steps of carried out by a discoverable user device.

Steps 311, 312 and 313 are corresponding to those of FIG. 3a in which the discoverable user device, for example the user device 120a, 140a, 150a, 170a and/or 220, is configured for a range class, receives the discovery range class configuration information and determines the discovery range class parameters.

In this embodiment, the determination of the discovery range class parameters may comprise determining a resource group to be used to transmit a discovery signal/beacon. In some embodiments, the discovery range class information/parameters may indicate a transmission power to be used in the transmission.

At step 314, the discoverable user device transmits a discovery signal/beacon according to the determined discovery range class parameters.

FIG. 3c is an exemplifying flow diagram depicting the method steps of carried out by a network node. In some embodiments, the network node may be an access point, for example the access point 210. In other embodiments, the network node may be any node having a higher hierarchy than the user device, or a node in communication with the communication system.

At step 321 in FIG. 3C, the network node may generate discovery range class configuration information. The information may explicitly or implicitly indicate the discovery range class parameters. The information may be generated from information for other network nodes, on the basis of communication conditions of the cell(s) in which the user device operate, system requirements and/or other requirements of the communication system.

At step 322, the network node may transmit this information to the user device within a cell served by or associated with the network node. For example, the network node may broadcast or multicast the discovery range class configuration information.

Different ones of the plurality of resource groups may be associated with different range classes. The range class may be a proximity services parameter to be used in proximity-based service discovery. The first range class may be a range class in which the user device is discoverable for a proximity-based service.

The signal may be a beacon indicating that the first user device is available for proximity-based service.

In one embodiment, information indicating the association between each of the plurality of resource groups and the range classes is received from a network node, host or server. The information may be received via one of the following: a multicast transmission of the network node, host or server; and broadcast transmission of the network node, host or server. The method may be carried out in an apparatus. The apparatus may be provided in a user device.

The discovery user device may be a device suitable for determining whether to discover a discoverable user device. The discovery user device may determine whether the discovery user device and discoverable user device are within each other's ranges. In one embodiment, this determination may make use of thresholds.

In one embodiment, the discovery user device may select a set of thresholds based on its discovery range class. The set of threshold may include thresholds corresponding to respective available range classes. A threshold from the set may be selected based on the range class of the discoverable user device and may be compared to the determined transmit power of the discoverable user device's discovery signal/beacon. In some embodiments, the thresholds may be thresholds for transmit power.

The range class may correspond to a range in which a user device is discoverable for a proximity-based service. Each user device may be associated with one of the plurality of range classes. The apparatus may be in a network node, host or server

According to another embodiment, there is provided an apparatus, said apparatus comprising at least one processor and at least one memory including computer code for one or more programs, the at least one memory and the computer code configured, with the at least one processor, to cause the apparatus at least to: associate each of a plurality of resource groups with a respective range class of a plurality of range classes; and cause information to be transmitted indicating the association to a plurality of user devices.

The range class may correspond to a range in which a user device is discoverable for a proximity-based service. Each user device may be associated with one of the plurality of range classes.

The signal may be a beacon indicating an availability of the first user device for proximity-based service. The proximity-based service range class may correspond to a range in which a user device is suitable for carrying out proximity-based service.

The range class may correspond to a range in which a user device is discoverable for a proximity-based service. Each user device may be associated with one of the plurality of range classes.

The selecting the threshold may comprise: selecting a set of thresholds based on the second proximity-based service range class; and selecting the threshold from the selected set of thresholds based on the first proximity-based service range.

The signal may be a beacon indicating an availability of the first user device for proximity-based service.

The proximity-based service range class may correspond to a range in which a user device is suitable for carrying out proximity-based service.

The proximity-based service range class may correspond to a range in which a user device is suitable for carrying out proximity-based service.

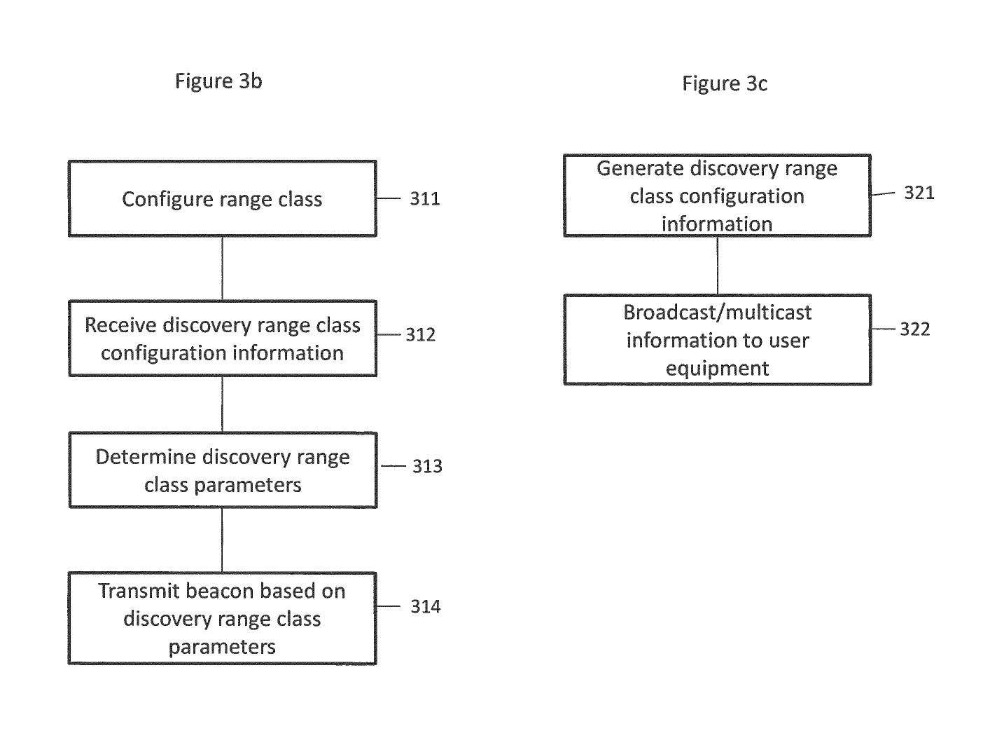

FIG. 4 shows an example of the sets of thresholds and their relation to a transmit power of a range.

FIG. 4 is a graph plotting the power of a discovery signal/beacon 401 received at a discovery user device against the distance 402 of the discoverable user device from the discovery user device when transmitting the discovery signal.

FIG. 4 shows an example of the case where the discoverable user device is within a short range 406, medium range 407 and maximum range 408 of the discovery user device as well as the case where the range class of the discoverable user device is short 403, medium 404 and maximum 405.

In the example of FIG. 4, three sets of thresholds are shown. A first set of thresholds 410 to be selected when the range class of the discovering user device is short, a second set of threshold 420 when the range class of the discovering user device is medium and a third set of thresholds 430 when the range class of the discovering user device is maximum 430.

In the embodiment where the transmit power of a discovery signal/beacon of a discoverable user device is set by the discovery range class parameters, it may be seen that the further the discoverable user device is from the discovery user device, the lower the power of the discovery signal/beacon that is received at the discovery user device. In this case, if the discovering user device has a maximum range class, the set of threshold(s) 430 are lower as this discovery user device may discover user device the furthest away. If the discovery user device has a short range class, the set of thresholds 410 are higher, as the received power of discovery signals/beacons of discoverable user device within a short range of the discovery user device are expected to be higher than those of discoverable user device further away.

In the example of FIG. 4 a discoverable user device with a short range class may transmit at a lower power than a discoverable user device with a maximum range class. Thus, a discoverable user device with a maximum range class within a short range of a discovery user device may be expected to have a higher received power 441 than the power 442 of a discoverable user device with a short range class within a short range of the discovery user device,

Referring to FIG. 1, the discovery user device 130a may have a maximum range class 130b. It may receive discovery signal/beacon from a discoverable user device 140a with a short range class 140b. The discovery user device may select the set of thresholds 430 for a discovery user device with a maximum range class. The discovery user device 130a may determine from the discovery signal/beacon, that the discoverable user device 140a has a short range class.

The set of thresholds 410 may comprise a first threshold T1_SHORT, a second threshold T2_SHORT and a third threshold T3_SHORT. The first threshold may be associated with a first range class, the second threshold may be associated with a second range class and the third threshold may be associated with a third range class. In this examples the threshold T1, T2 and T3 are associated with a short, medium and maximum range class of the discoverable user device respectively. The first set of threshold associated with a discovering user device with a short range class may comprise thresholds for short, medium and maximum range classes of the discoverable device.

The second set of thresholds may comprise only two thresholds T2_MEDIUM and T3_MEDIUM for a medium and maximum range of a discoverable user device while the third set of thresholds may comprise only one threshold T3_MAXIMUM.

Referring to FIG. 4, the discoverable user device 140a is within a short range of the discovery user device 130a and the received power of its discovery signal/beacon may resemble 442 as this is the power of a discoverable user device with a short range class within a short range of the discovery user device. The power 442 is above the threshold T3_MAX. The discovery user device 130a may determine that the discoverable user device 140a may be discovered, T3_MAX may be selected as the threshold for a discoverable user device with a short, medium and/or maximum range class. A beacon of a discoverable user device with a short range class will exceed the threshold when in short range, but should not exceed the threshold when in medium or maximum range. A beacon of a discoverable user device with a medium range class will exceed the threshold when in short and medium range, but should not exceed the threshold when in maximum range.

In another example, the discovery user device 160a may have a short range class 160b and thus may choose the set of thresholds 410. The discovery user device 160a may receive a beacon from a discoverable user device 150a with a maximum range class. The discovery user device 160a may determine that the discoverable user device 150a has a maximum range class and select a first threshold T3_SHORT. A comparison between the received power of the beacon and the threshold determines that the discoverable user device 150a may not be discovered. As may be seen from FIG. 1, the discoverable user device 150a does not fall within the range 160b where the discovery user device 160a may discover it.

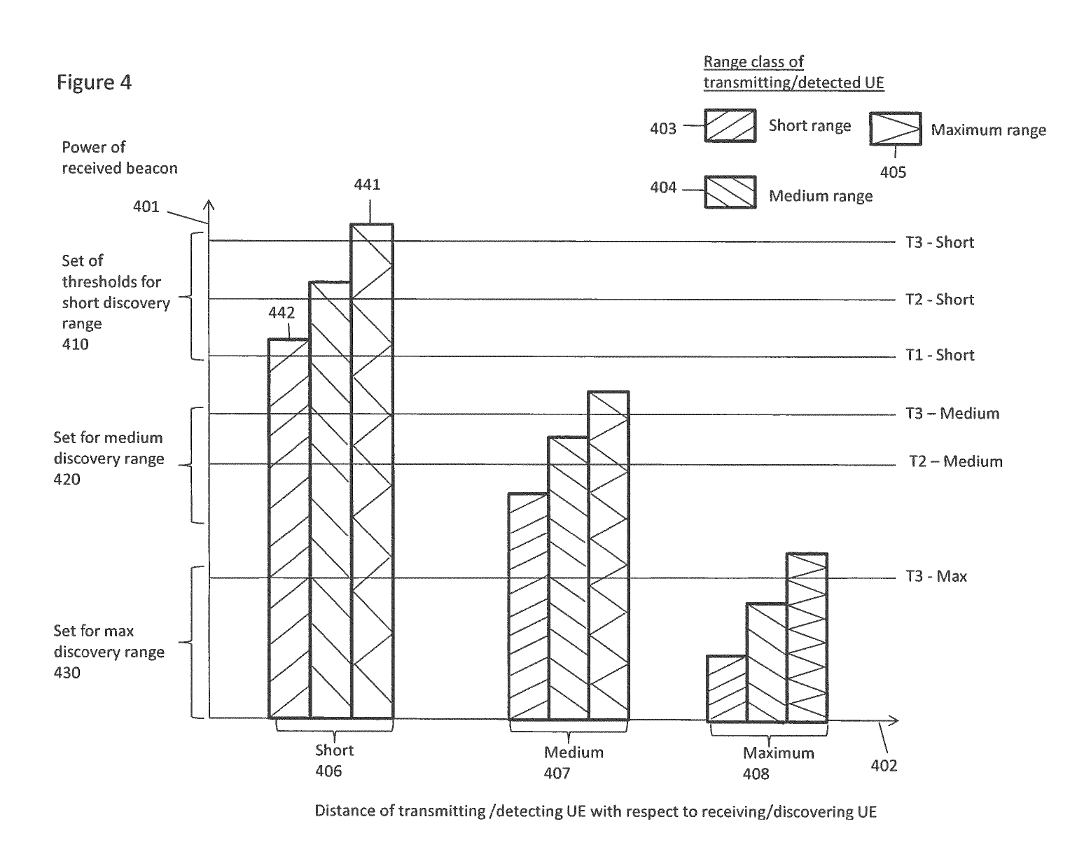

FIG. 5 is a flow diagram depicting the method steps relating to determining whether a user device may be discovered.

At step 501, a discovery signal/beacon is received from a discoverable user device. At step 502 a resource group used to transmit the beacon is used to determine a range class of the detectable user device.

At step 503, the range class of a discovery user device is used to select a set of thresholds corresponding to that range class. At step 504, a threshold from the set of thresholds is selected based on the range class of the discoverable user device.

At step 505, the received power of the beacon is compared to the threshold to determine whether the discoverable user device may be discovered.

In some embodiments, the possible proximity-based service (D2D/ProSe) range class related configuration or information may comprise:
discovery signal transmission power for each range class: the transmission power may be indicated explicitly for each range class, or only transmission powers for maximum and minimum range class and also the number of range classes are indicated so that UE can derive the transmission power for the interested range class accordingly, or the transmission power for one range class (e.g. maximum or minimum range class) is indicated and the rules to derive the transmission power for other class is either hard-coded or indicated. For implicit indication option, the transmission power of different range class may be derived from cell size or reference signal power of the serving cell based on either pre-defined rules or indicated rules by the network. For example, the transmission power of maximum range class may be set corresponding to the cell size or according to reference signal power with given offset.
discovery resource (i.e. ProSe discovery signal sequence and frequency/time resource allocated for ProSe discovery signal transmission) group for each range class: The group division can be equal so that the ProSe discovery resource group for each range class is known based on the number of supported range classes. Or the group division is explicitly indicated by the serving network to allow more dynamic change of ProSe discovery resource group for each range class.
Range class dependent ProSe discovery detection threshold: the threshold is used for discovering UE to determine if detected ProSe discovery signal can be regarded as proximity discovered or not depending on which group the detected ProSe discovery signal belongs to. The threshold may be given explicitly for each range class, or the threshold for certain range class is given explicitly and the threshold for other range class can be derived accordingly based on the indicated ProSe discovery signal transmission power for each range class.
To allow the discovering UE to use discovery range class, it is proposed that discovering UE may make proximity detection decision based on the detected ProSe discovery signal group and also the interested discovering range class. That is the discovering UE makes proximity discovery decision only if the received power of beacon signal from the other UE is larger than detection threshold that is discovery signal group dependent and as well as discovering UE interested range class dependent. For instance, if one UE is interested in discovering UEs within short range class, it considers to discover UE#1 with discovery resource group targeted for short range class if received power is larger than threshold T1_s, and to discover UE#2 with discovery resource group targeted for medium range class if received power is larger than threshold T2_s, and to discover UE#3 with discovery resource group targeted to maximum range class if received power is larger than threshold T3_s, where T1_s<T2_s<T3_s are short discovering range class specific. For other discovering range classes (e.g. medium and maximum) the set of discovering detection thresholds might be different.

In an apparatus suitable for carrying out embodiments described above, each block of the flowcharts and any combination thereof may be implemented by various means or their combinations, such as hardware, software, firmware, one or more processors and/or circuitry. It should be understood that the apparatus may comprise radio parts or it may operationally coupled to external radio parts, such as a remote radio head.

An apparatus suitable to carry out embodiments described above may in general include at least one processor, controller or a unit designed for carrying out control functions and being operably coupled to at least one internal or external memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it.

In one embodiment, the at least one memory and the computer code may be configured, with the at least one processor, to cause the apparatus to receive information indicating an association of each of the plurality of resource groups with a respective range class. The information may be received from a network node, host or server providing communication services. The apparatus may be in a user device.

In another embodiment, the at least one memory and the computer code may be configured, with the at least one processor, to cause the apparatus to select a set of thresholds based on the second proximity-based service range class; and select the threshold from the selected set of thresholds based on the first proximity-based service range. The apparatus may be in a user device.

The signal may be a beacon indicating an availability of the first user device for proximity-based service.

The information may further indicate at least one of: a transmission power associated with at least one range class; and at least one of threshold associated with the at least one range class. The information may be received via one of the following: a multicast transmission of the network node, host or server; and broadcast transmission of the network node, host or server. The apparatus may be in a user device.

The range class may be a proximity services parameter to be used in proximity-based service discovery. The first range class may be a range class in which the user device is discoverable for a proximity-based service. The signal may be a beacon indicating that the first user device is available for proximity-based service.

The receiving means may be for receiving information indicating an association of each of the plurality of resource groups with a respective range class. The information may be received from a network node, host or server providing communication services. The information may further indicate at least one of: a transmission power associated with at least one range class; and at least one of threshold associated with the at least one range class.

The information may be received via one of the following: a multicast transmission of the network node, host or server; and broadcast transmission of the network node, host or server. The apparatus may be in a user device.

The at least one memory and the computer code may be configured, with the at least one processor, to cause the apparatus to receive information indicating the association between each of the plurality of resource groups and the range classes from a network node, host or server. The apparatus may be in a user device.

The information may be received via one of the following: a multicast transmission of the network node, host or server; and broadcast transmission of the network node, host or server. The apparatus may be in a user device.

An example of an apparatus comprises at least one processor and at least one memory including computer code for one or more programs, the at least one memory and the computer code configured, with the at least one processor, to cause the apparatus at least to: associate each of a plurality of resource groups with a respective range class of a plurality of range classes; and cause information to be transmitted indicating the association to a plurality of user devices. The apparatus may be a network node, host or server.

An example of an apparatus may comprise means for receiving information indicating the association between each of the plurality of resource groups and the range classes from a network node, host or server. The information may be received via one of the following: a multicast transmission of the network node, host or server; and broadcast transmission of the network node, host or server.

Another example of an apparatus may comprise means for selecting a resource group from a plurality of resource groups based on a range class of a user device carrying out proximity-based service discovery, wherein each of the plurality of resource groups is associated with a range class, and means for causing a signal to be transmitted on at least one resource of the selected group.

Yet another example of an apparatus may comprise means for associating each of a plurality of resource groups with a respective range class of a plurality of range classes, and means for causing information to be transmitted indicating the association to a plurality of user devices.

Yet another example of an apparatus may comprise means for receiving a signal from a first user device at a second user device, the signal having a reception power and indicating a first proximity-based service range class associated with the first user device, means for selecting a threshold based on a second proximity-based service range class associated with the second user device and the first proximity-based service range; and means for determining, if proximity-based service is supported between the first and the second user device based on the threshold and the reception power.

The means for selecting may be for: selecting a set of thresholds based on the second proximity-based service range class; and selecting the threshold from the selected set of thresholds based on the first proximity-based service range.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

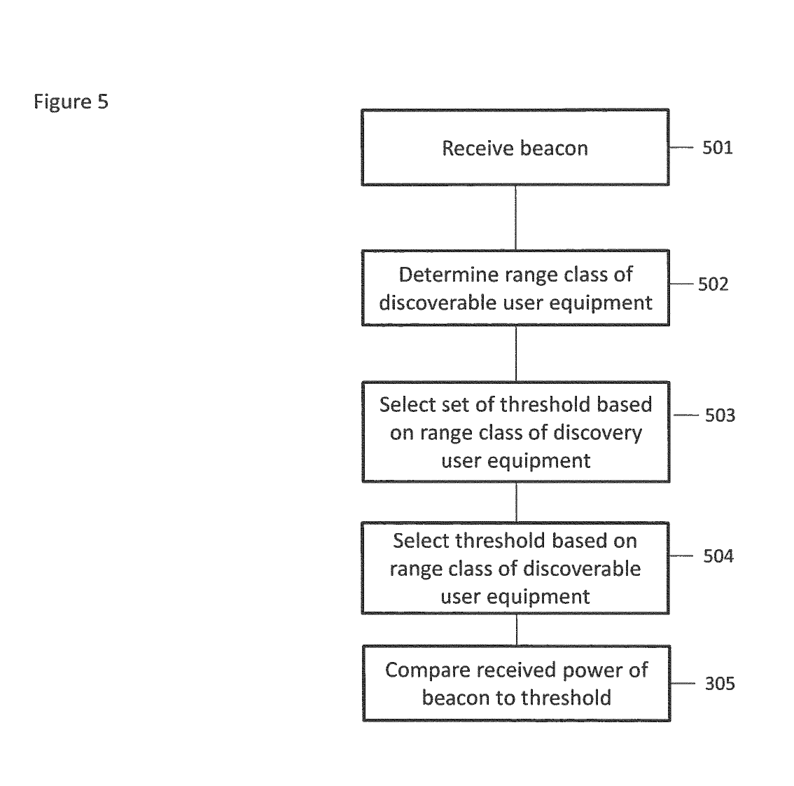

A possible user device, such as a mobile communication device for transmitting to and receiving from a plurality of access nodes or base stations will now be described in more detail with reference to FIG. 6 showing a schematic, partially sectioned exemplifying view of a mobile communication device 600. Such a device is often referred to as user device (UE) or terminal. An appropriate mobile communication device may be provided by any device capable of sending radio signals to and/or receiving radio signals from multiple cells or to/from another user device during proximity services or device to device communication. Non-limiting examples include a mobile station (MS) such as a mobile phone or what is known as a ‘smart phone’, a tablet or a portable computer provided with a wireless interface card, and USB stick or ‘dangle’ with radio, or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on.

The mobile device may receive and transmit signals over an air interface 607 with multiple base stations via an appropriate transceiver apparatus. In FIG. 6 transceiver apparatus is designated schematically by block 606. The transceiver apparatus 606 may be provided for example by means of a radio part and associated antenna arrangement. The radio part is arranged to communicate simultaneously with different stations. The radio part may also be arranged to communicate via different radio technologies. For example, the radio part can provide a plurality of different radios. The antenna arrangement may be arranged internally or externally to the mobile device.

A mobile communication device is also provided with at least one data processing entity 601, such as a processor, at least one memory 602 and other possible components 603 for use in software and hardware aided execution of tasks it is designed to perform, including control of access to and communications with access systems and/or other communication devices. The data processing, storage and other relevant control apparatus can be provided on an appropriate circuit board and/or in chipsets. This feature is denoted by reference 604. The at least one memory may be implemented as at least one memory unit within the processor or externally to the processor. In the latter case it may be communicatively coupled to the processor via various means, as is known in the art. The mobile communication device may also use cloud services.

The user may control the operation of the mobile device by means of a suitable user interface such as key pad 605, voice commands, touch sensitive screen or pad, combinations thereof or the like. A display 608, a speaker and a microphone can also be provided. Furthermore, a mobile communication device may comprise appropriate connectors (either wired or wireless) to other devices and/or for connecting external accessories, for example hands-free device, thereto.

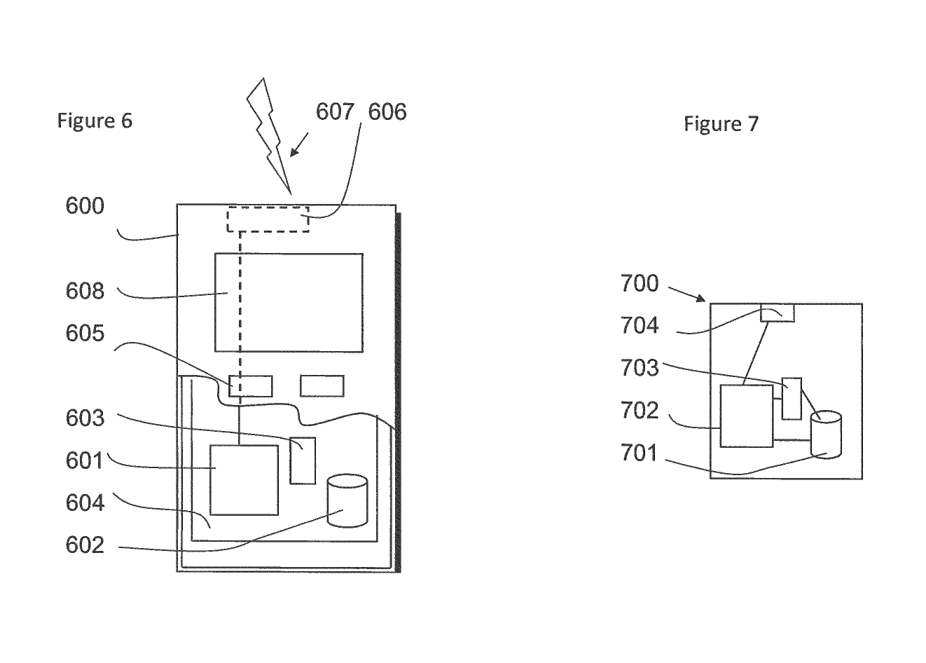

FIG. 7 shows an example of a control apparatus for a communication system. The control apparatus may be located in a network control entity, such as in a (e)NodeB, or elsewhere in the system being operably coupled to the entity to be controlled. The control apparatus 700 can be arranged to provide control on communications in the service area of a cell to provide the functions described below. The control apparatus 700 can be configured to provide control functions in association with configurations for dual connectivity arrangements by means of the data processing facility in accordance with certain embodiments described below. For this purpose the control apparatus comprises at least one memory 701, at least one data processing unit 702, 703 and an input/output interface 704. Via the interface the control apparatus can be coupled to a receiver and/or a transmitter. The receiver and/or transmitter may also be implemented as a remote radio head. The control apparatus can be configured to execute an appropriate software code to provide the control functions. It shall be appreciated that similar component can be provided in a control apparatus provided elsewhere in the system for controlling configurations of secondary nodes/cells.

An appropriately adapted computer program code product or products may be used for implementing the embodiments, when loaded on an appropriate data processing apparatus, for example for determining geographical boundary based operations and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof.

It should be understood that conveying, broadcasting, signalling, transmitting and/or receiving may herein mean preparing a data conveyance, broadcast, transmission and/or reception, preparing a message to be conveyed, broadcasted, signalled, transmitted and/or received, or physical transmission and/or reception itself, etc. on a case by case basis. The same principle may be applied to the terms transmission and reception as well.

It is also noted herein that while the above describes exemplifying embodiments of the invention, there are several variations and modifications which may be made to the disclosed solution without departing from the scope of the present invention.

1-24. (canceled)

25. An apparatus, said apparatus comprising at least one processor and at least one memory including computer code for one or more programs, the at least one memory and the computer code configured, with the at least one processor, to cause the apparatus at least to:
receive a signal from a first user device, the signal being transmitted using at least one resource of one group of a plurality of resource groups, the one of the plurality of resource groups being associated with a first range class; and
determine the first range class based on the one of the plurality of resource groups.

26. The apparatus as claimed in claim 25, wherein different ones of the plurality of resource groups are associated with different range classes and wherein the first range class is a proximity services parameter to be used in proximity-based service discovery.

27. The apparatus of claim 26, wherein the different range class corresponds to different ranges within which carrying out a proximity-based service is suitable.

28. The apparatus as claimed in claim 25, wherein the first range class is a range class in which the user device is discoverable for a proximity-based service.

29. The apparatus as claimed in claim 25, wherein the signal is a beacon indicating that the first user device is available for proximity-based service.

30. The apparatus as claimed in claim 25, the at least one memory and the computer code configured, with the at least one processor, to further cause the apparatus at least to:
receive information indicating an association of each of the plurality of resource groups with a respective range class and wherein the information is received from a network node, host or server providing communication services.

31. The apparatus as claimed in claim 25, the at least one memory and the computer code configured, with the at least one processor, to further cause the apparatus at least to:
receive information indicating an association of each of the plurality of resource groups with a respective range class and wherein the information further indicates at least one of:
a transmission power associated with at least one range class; and
at least one of threshold associated with the at least one range class.

32. The apparatus as claimed in claim 25, the at least one memory and the computer code configured, with the at least one processor, to further cause the apparatus at least to:
receive information indicating an association of each of the plurality of resource groups with a respective range class and wherein the information further indicates at least one of: a transmission power associated with at least one range class; and at least one of threshold associated with the at least one range class, and wherein the information is received via one of the following: a multicast transmission of the network node, host or server; and broadcast transmission of the network node, host or server.

33. The apparatus as claimed in claim 25, the at least one memory and the computer code configured, with the at least one processor, to further cause the apparatus at least to:
determine based at least on the first range class whether the first user device is discoverable.

34. An apparatus, said apparatus comprising at least one processor and at least one memory including computer code for one or more programs, the at least one memory and the computer code configured, with the at least one processor, to cause the apparatus at least to:
select a resource group from a plurality of resource groups based on a range class of a user device carrying out proximity-based service discovery, wherein each of the plurality of resource groups is associated with a range class; and
cause a signal to be transmitted on at least one resource of the selected group.

35. The apparatus of claim 34 further comprising causing the apparatus to:
receive information indicating the association between each of the plurality of resource groups and the range classes from a network node, host or server.

36. The apparatus of claim 34, further comprising causing the apparatus to:
receive information indicating the association between each of the plurality of resource groups and the range classes from a network node, host or server and wherein the information is received via one of the following: a multicast transmission of the network node, host or server; and broadcast transmission of the network node, host or server.

37. The apparatus of claim 34, further comprising causing the apparatus to:
receive information indicating an association between the apparatus and a range class from a network node, host or server.

38. The apparatus of claim 37, wherein the association varies according to at least one of an area topology, a number of devices in an area, an interference and an attenuation.

39. The apparatus of claim 37, further comprising causing the apparatus to receive at least a threshold associated with the range class associated with the apparatus.

40. The apparatus of claim 37, further comprising causing the apparatus to receive at least a threshold for each the range classes.

41. An apparatus, said apparatus comprising at least one processor and at least one memory including computer code for one or more programs, the at least one memory and the computer code configured, with the at least one processor, to cause the apparatus at least to:
receive a signal from a first user device at a second user device, the signal having a reception power and indicating a first proximity-based service range class associated with the first user device; and
select a threshold based on a second proximity-based service range class associated with the second user device and the first proximity-based service range; and determine, if proximity-based service is supported between the first and the second user device based on the threshold and the reception power.

42. The apparatus as claimed in claim 41, wherein the signal is a beacon indicating an availability of the first user device for proximity-based service.

43. The apparatus of claim 41, wherein the proximity-based service range class corresponds to a range in which a user device is suitable for carrying out proximity-based service.
